(19) United States
(12) Patent Application Publication
(10) Pub. No.: US 2026/0332065 A1
(43) Pub. Date: Oct. 22, 2026

(54) FRONT-END SINGLE-STAGE STEP UP - STEP DOWN THREE-LEVEL INVERTER

(71) Applicant: Ariel Scientific Innovations Ltd., Ariel (IL)

(72) Inventor: Ilan AHARON, Ariel (IL)

(73) Assignee: Ariel Scientific Innovations Ltd., Ariel (IL)

(21) Appl. No.: 19/104,378

(22) PCT Filed: Aug. 18, 2023
(86) PCT No.: PCT/IL2023/050879

§ 371 Date: Feb. 18, 2025

Related U.S. Application Data
(60) Provisional application No. 63/398,914, filed on Aug. 18, 2022.

(51) Int. Cl. H02M 7/5387; H02M 1/00; H02M 7/487

(52) U.S. Cl. CPC H02M 7/53873; H02M 1/0095; H02M 7/487

(57) ABSTRACT

A multi-level t-type inverter for connecting a DC source to an AC grid, comprises: a high frequency power inductor; a positive terminal for connection to a positive DC voltage source; a negative terminal for connection to a negative DC voltage source; a grid terminal for connection to an AC grid; a neutral terminal for connection to a neutral connection of said AC grid; three bi-directional switches; and an output pair filter. The three bidirectional switches may each provide a different current path to charge or discharge the high frequency power inductor.

### RELATED APPLICATION/S

This application claims the benefit of priority under 35 USC § 119(e) of U.S. Provisional Patent Application No. 63/398,914 filed Aug. 18, 2022, the contents of which are incorporated herein by reference in their entirety.

### FIELD AND BACKGROUND OF THE INVENTION

The present invention relates to a front end single stage step up step down three-level inverter and more particularly but not exclusively to the use of such an inverter to connect a DC source to an AC grid—or an electric motor or any load that requires an ac source.

DIRECT current (DC) photovoltaic sources and battery energy storage systems (BESS) are prevalent on a modern electric grid. To utilize the DC battery energy into the alternating current (AC) electric grid an inverter is required. One of the most common inverter families is the multi-level inverter (MLI). The ancestor of most of the non-isolated MLIs is the buck converter which requires that the supply voltage is higher than the sinusoidal amplitude. Nevertheless, the basic battery cell is ~4V; consequently, a BESS requires a series connection of about 200 cells. Since this task is nontrivial in most of the designs, an additional bidirectional power converter is utilized to attach a BESS to the inverter DC-link. Hence, overall system cost, efficiency, reliability, and volume are affected. A buck-boost converter is capable of swinging the output voltage above and below the input voltage. However, besides the indirect current feature of buck-boost that increases the inductor peak current, the converter inverts the output voltage and thus narrows the range of optional applications.

Neutral point clamped (NPC) inverters are a family of multilevel power converters that are characterized by utilizing clamping diodes for guaranteeing proper voltage sharing across power switches. The three-level NPC inverters offer superior waveform quality to two-level inverters, and therefore, they are a widespread multilevel converter topology, as they offer very attractive performance with limited complexity. Each NPC inverter leg contains four transistors and two diodes. A three-level t-type inverter (T²I) is similar to the three-level NPC, offering improved harmonic performance. The 3LT²I requires two standard transistors connected in series from positive (P) to negative (N) DC-link voltage and a bi-directional switch implemented by two transistors (common source configuration) between the transistor's middle point and the neutral (total four transistors per each leg). In contrast to the NPC topology where two devices are always connected in series whenever the output is connected to P or N, in 3LT²I only one device is connected. The T²I performances are the highest among the two-level and three-level inverters reaching 99% at 10 kW. However, transformer-less two-level inverter, NPC inverter, and the T²I require supply P and N voltages which are higher than the sinusoidal amplitude voltage.

### SUMMARY OF THE INVENTION

The present embodiments may provide a topology for a three-level T-type universal inverter (T²UI). The T²UI of the present embodiments may support applications where the sinusoidal amplitude is higher or lower than the positive P and negative N supply voltages.

According to a first embodiment of the present invention, there is provided a multi-level t-type inverter for connecting a DC source to an AC grid, the inverter comprising:
a high-frequency power inductor;
a positive terminal for connection to a positive DC voltage source;
a negative terminal for connection to a negative DC voltage source;
a grid terminal for connection to an AC grid;
a neutral terminal for connection to a neutral connection of the AC grid;
multiple bi-directional switches; and
an output pair LC filter between the high-frequency power inductor and the grid and neutral terminals.

The inverter may include a cascade dual-loop controller. The cascade dual loop controller may include an inner fast inductor current loop, a pulsed width modulator (PWM) module, and an outer voltage control loop. The inner fast inductor current loop may initiate operation of the pulsed width modulator (PWM) module and the outer voltage control loop. The cascade dual loop controller may charge and discharge the high-frequency power inductor. The cascade dual loop controller may charge and discharge the high-frequency power inductor via a first charge path and a first discharge path for a positive half sine wave, and a second charge path and a second discharge path for a negative half sine wave. The first charge path may extend from the neutral terminal to the negative DC terminal via the high-frequency power inductor and a first of the bidirectional switches, and the second charge path may extend from the positive DC terminal to the neutral terminal via the high-frequency power inductor and a second of the bidirectional switches. On the other hand, the first discharge path may extend from the neutral terminal back to the neutral terminal via the high-frequency power inductor, the output pair filter, and a third of the bidirectional switches. The second discharge path may extend from the neutral terminal back to the neutral terminal via a third of the bidirectional switches and the high-frequency power inductor. Another option is a three-loop cascade control where the inner loop is the inductor current loop, the middle is the output sine wave voltage or current amplitude, and the outer loop is for maximum power point tracking (MPPT) for a photo-voltaic source. The third, outer, loop could also be a standard power loop or minimum fuel consumption (MFC) point or any other minimization target function for optimizing the system operation.

The multi-level t-type inverter may be a three-level inverter, and the number of bidirectional switches may be three.

In embodiments, a first of the plurality of bidirectional switches is located between the power inductor and the positive AC input, a second of the plurality of bidirectional switches is located between the power inductor and the negative AC input and a third of the plurality of bidirectional switches is located between the power inductor and the output LC filter.

A controller may operate the bidirectional switches, the controller configured such that the first charge path is achieved by opening the first and third bidirectional switches and closing the second bidirectional switch, the second charge path is achieved by opening the second and third bidirectional switches and opening the first bidirectional switch, and the first and second discharge paths are achieved by opening the first and second bidirectional switches and closing the third bidirectional switch.

In embodiments, the third bidirectional switch comprises first and second pulse width modulation (pwm) switches, and the controller is configured to initiate a positive half sine wave by charging the power inductor, by operating a first of the pwm switches using:

PWM₂ₐ(t)=k₁(t)·sign(sin(f_{grid}·πt)) (8)

and a second of the PWM switches using:

PWM_{2b}(t)=sign(sin(f_{grid}·πt)) (9)

In embodiments, the first bidirectional switch comprises first and second pulse width modulation (pwm) switches, and the controller is configured to initiate a negative half sine wave by feeding the power inductor by operating a first of the pwm switches of the first bidirectional switch according to

PWM₁ₐ(t)=k₁(t)·s̅i̅g̅n̅(̅s̅i̅n̅(̅f̅_̅{̅g̅r̅i̅d̅}̅·̅π̅t̅)̅)̅ (10)

and operating a second of the pwm switches of the first bidirectional switch according to

PWM_{1b}(t)=s̅i̅g̅n̅(̅s̅i̅n̅(̅f̅_̅{̅g̅r̅i̅d̅}̅·̅π̅t̅)̅)̅ (11)

In embodiments, the controller is configured such that control logic signals for driving the switches are based on a basic modulation command

k₁(t)=α(t)·|sin(f_{grid}·πt)| (1)

where α(t) is

α(t)=V_{dc}·d(t)/((1−d(t))) (2)

In embodiments, the controller is configured to charge the power inductor 12 by operating first and second pwm switches of the second bidirectional switch using:

PWM₂(t)=k₁(t)·sign(sin(f_{grid}·πt)) (3).

In embodiments, the controller is configured to discharge the power inductor to transfer energy to the grid via the third bidirectional switch, the third bidirectional switch comprising first and second pwm switches Q₃ₐ and Q_{3b}, where Q_{3b} is idle, and Q₃ₐ is operated using

PWM₃ₐ(t)=k̅₁̅(t)·sign(sin(f_{grid}·πt)) (4)

where k̅₁̅(t)∝α̅(t) and

α̅(t)=V_{dc}·d̅(t)/((1−d̅(t))) (5)

In embodiments, the first bidirectional switch comprises first Q1a and second Q1b pwm switches, the controller bine configured such that during the negative half sine wave the inductor is fed from the positive AC terminal through the first bidirectional switch, wherein the first and second pwm switches of the first bidirectional switch are operated using

PWM₁(t)=k₁(t)·s̅i̅g̅n̅(̅s̅i̅n̅(̅f̅_̅{̅g̅r̅i̅d̅}̅·̅π̅t̅)̅)̅ (6)

In embodiments, the controller is configured to discharge the power inductor to transfer energy to the grid via the third bidirectional switch, the third bidirectional switch comprising first and second pwm switches Q₃ₐ and Q_{3b}, where Q_{3b} is idle, and Q₃ₐ is operated using

PWM_{3b}(t)=k̅₁̅(t)·s̅i̅g̅n̅(̅s̅i̅n̅(̅f̅_̅{̅g̅r̅i̅d̅}̅·̅π̅t̅)̅)̅ (7)

In embodiments, the controller is configured to operate over a full sinusoidal cycle via a sequence comprising for each quarter of the cycle closing in order the second bidirectional switch, the third bidirectional switch, the first bidirectional switch and the third bidirectional switch.

According to a further aspect of the present invention there is provided a method for manufacturing a multi-level t-type inverter, for connecting a DC source to an AC grid, the method comprising:
providing a high frequency power inductor;
providing a positive terminal for connection to a positive DC voltage source;
providing a negative terminal for connection to a negative DC voltage source;
providing a grid terminal for connection to an AC grid;
providing a neutral terminal for connection to a neutral connection of the AC grid;
providing a plurality of bi-directional switches, each of the plurality of bidirectional switches defining a respectively different current path through the inverter, each path including the high frequency power inductor; and
providing an output LC filter.

According to a yet further aspect of the present invention there is provided a method for connecting a DC power source to an AC grid, comprising:
connecting a high frequency power inductor between a neutral terminal and a common terminal;
connecting a first bidirectional switch between a positive terminal of the DC power source and the common terminal;
connecting a second bidirectional switch between a negative terminal of the DC power source and the common terminal;
connecting a third bidirectional switch between the common terminal and an AC output terminal;
providing a positive half sine wave by successively closing the first and the third bidirectional switches; and
providing a negative half sine wave by successively closing the second and the third bidirectional switches.

A method of connecting a DC power source to an AC grid may involve using the inverter described above.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are schematic circuit diagrams showing a front-end single-stage step up-step down three-level inverter according to a first embodiment of the present invention;

FIG. 1C is a schematic diagram showing a controller for operating the inverter of FIG. 1a via inputs to each of the bidirectional gates;

FIGS. 2A-2C are three views of the circuit of FIG. 1(a) being switched for a positive part of a sine wave input;

FIGS. 3A-3C are three views of the circuit of FIG. 1(a) being switched for a negative part of a sine wave input;

FIG. 4 is a simplified graph showing DC against against AC signals of the inverter of the present embodiments; and

FIG. 5 is a simplified graph showing magnetization as a function of applied field in the inverter of the present embodiments.

### DETAILED DESCRIPTION OF THE PRESENT EMBODIMENTS

As stated above, the present invention relates to a front-end single-stage step up step down three-level inverter and more particularly but not exclusively to the use of such an inverter to connect a DC source to an AC grid,—or directly to a load such as an electric motor that requires an AC source.

The present embodiments may provide a multi-level t-type inverter for connecting a DC source to an AC grid, which inverter has a high frequency power inductor, a positive terminal for connection to a positive DC voltage source, a negative terminal for connection to a negative DC voltage source, a grid terminal for connection to an AC grid, a neutral terminal for connection to a neutral connection of said AC grid and a number, typically three, of bi-directional switches, each of which may define a respectively different current path through the high frequency power inductor. There may also be provided an output LC filter.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In the following the principles of operation and circuit analytics are introduced. Then the 3LT²UI circuit is modeled and simulated, presenting the proposed circuit performance in an open loop. Finally, T²UI circuit experimental results for the present topology are provided.

### Circuit Topology and Analysis

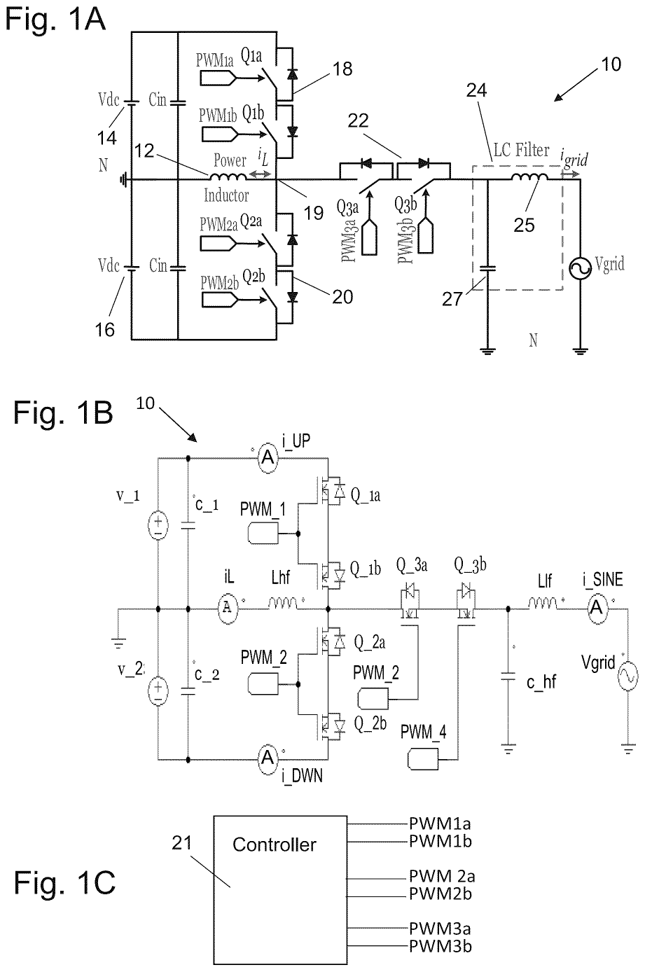

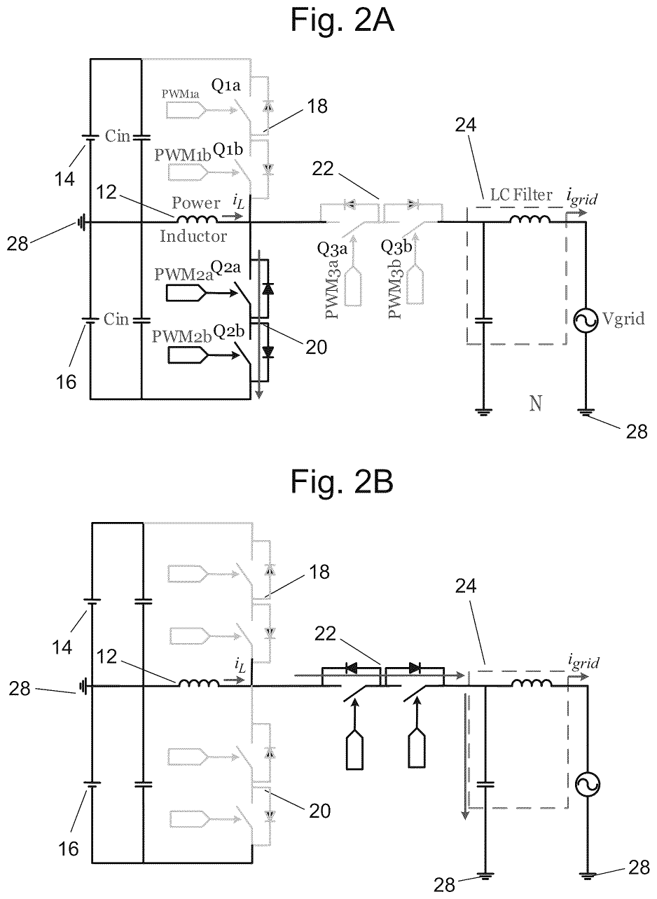

Reference is first of all made to FIGS. 1A and 1B, which illustrate a first embodiment of the present invention, which a single-phase three-level T-type universal inverter T²UI 10 is based on one high-frequency power inductor 12, positive 14 and negative 16 DC voltage source, three bi-directional switches, 18, 20 and 22, and an output pair LC filter 24 that connects to the AC grid. The T²UI may operate in continuous conduction mode (CCM) and discontinuous conduction mode (DCM) for one or three-phase inverters.

The high frequency power inductor may operate in a range starting at the tens of kilohertz and extending to megahertz, and the term ‘high frequency’ as used herein is to be construed accordingly.

The high frequency power inductor 12 is connected at a first end to a neutral terminal and at a second end to a common terminal 19 of the three bidirectional switches 18, 20 and 22. The first bidirectional switch is connected between the positive DC power input and the common terminal 19. The second bidirectional switch 20 is connected between the negative DC power input and the common terminal 19, and the third bidirectional switch 22 is connected between the common terminal 19 and the output filter 24. The output filter 24 is an DC filter made up of inductor 25 and capacitor 27 and is connected between the third bidirectional switch and the AC output to cancel out DC levels in the output.

The circuit of FIGS. 1A and 1B are controlled by controller 21 of FIG. 1C. The controller has two outputs for each of the bidirectional gates and controls the first bidirectional gate via pulse width modulation units PWM 1a and PWM 1b. The second bidirectional gate is controlled via PWM 2a and PWM 2b. The third bidirectional gate is controlled by the controller via PWM 3a and PWM 3b.

The controller 21 may be a cascade controller using multiple loops to control the inverter, for example two loops, three loops or four loops.

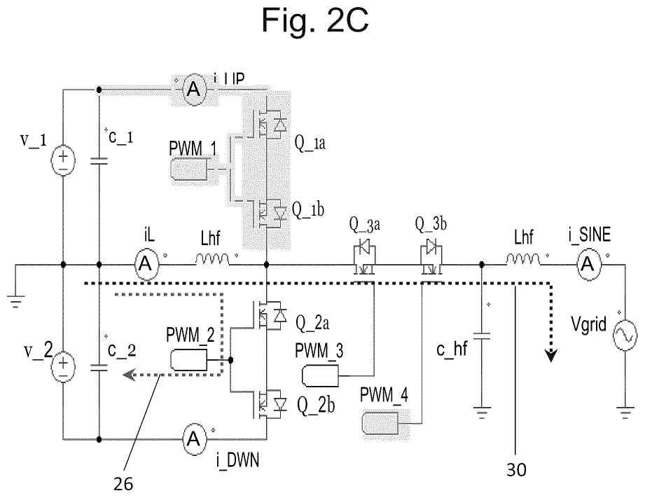

Reference is now made to FIGS. 2A to 2C, which illustrate different paths through the circuit of FIGS. 1A and 1B for the positive half sine wave. The paths are set up by opening and closing different bidirectional gates using controller 21, as will be explained. Each gate is associated with a specific current path through the inverter, and the current paths may be in different directions depending on whether a positive or negative half cycle is involved.

T²UI control circuitry includes a cascade dual loop controller 21. An inner fast inductor current loop initiates the pulsed width modulator (PWM) module which operates the bidirectional switches as explained, and the controller also operates an outer voltage control loop. The principle of operation for the positive half-sine wave includes two parts, a charge, and discharge of the T²UI high-frequency power inductor. The charge path 26 begins in the neutral point (N) DC-link 28, goes through the power inductor 12, then to the bi-directional switch 20 (Q2a, Q2b), and back to the N DC-link 28. In order to apply the charge path, switch 20 is closed and switches 18 and 22 are open as shown in FIG. 2A. The discharge path 30 continues with the same inductor current direction (clockwise) as the charge path, discharging the inductor 12 through the output bi-directional switch (Q₃ₐ, Q_{3b}) 22 to the output pair filter 24 and back to the neutral point as demonstrated in FIG. 2b. In order to apply the discharge path, switch 22 is closed and switches 18 and 20 are open as shown in FIG. 2B.

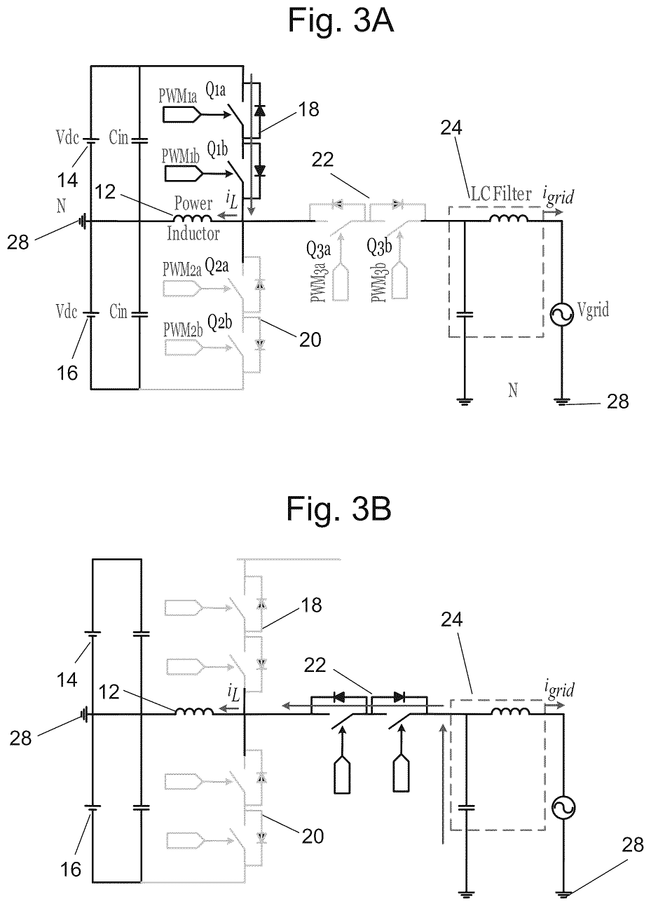

Reference is now made to FIGS. 3A to 3C which illustrates paths for charging and discharging the negative half sine wave. The negative half-sine wave is similar to the positive half sine wave as illustrated in FIGS. 2A to 2C above, and again includes two paths, one for a charge process and the other for a discharge process of the T²UI power inductor. The charge path, marked 40 in FIG. 3C, begins at the positive terminal 14 of V₁, passes through the bi-directional switch 18 (Q₁ₐ, Q_{1b}), to the high-frequency power inductor 12, and back to the neutral point 28. The charge path is achieved by closing switch 18 and opening switches 20 and 22, as presented in FIG. 3a. The discharge path, 42 in FIG. 3C continues with the same inductor current direction (clockwise), discharging the inductor 12 throughout the neutral point 28, to the output pair LC filter 24, to the bi-directional switch (Q₃ₐ, Q₃ₐ) 22 and returns to the inductor 12. The discharge path is achieved by closing switch 22 and opening switches 18 and 20, as shown in FIG. 3B.

Unlike standard NPC and T²I, the T²UI can support sinusoidal amplitudes higher or lower than the DC-bus as |V_{DC}|≥V_{M,sine} or |V_{DC}|≤V_{M,sine} (where |V₁|=|V₂|=|V_{DC}|). The control logic signals for driving the switches are based on a basic modulation command

k₁(t)=α(t)·|sin(f_{grid}·πt)| (1)

where α(t) is

α(t)=V_{dc}·d( t)/((1−d(t))) (2)

The positive half sine wave starts by charging the power inductor 12 right-handedly. At switch 20, Q₂ₐ and Q_{2b} operate by the following command:

PWM₂(t)=k₁(t)·sign(sin(f_{grid}·πt)) (3)

as the discharge process of the power inductor transfers its energy to the grid throughout Q₃ switches, where Q_{3b} is idle (operating as a diode), and Q₃ₐ command is

PWM₃ₐ(t)=k̅₁̅(t)·sign(sin(f_{grid}·πt)) (4)

where k̅₁̅(t)∝α̅(t) and

α̅(t)=V_{dc}·d̅(t)/((1−d̅(t))) (5)

In the Negative half sine wave the T²UI operates as follows. At the charge part, the inductor is fed from the positive terminal of V₁ throughout the switch 18 via Q₁ₐ and Q_{1b} using the logic

PWM₁(t)=k₁(t)·s̅i̅g̅n̅(̅s̅i̅n̅(̅f̅_̅{̅g̅r̅i̅d̅}̅·̅π̅t̅)̅)̅ (6)

The discharge of the high frequency power inductor 12 is through switch 22 and Q₃, where Q₃ₐ is idle (operating as a diode), and Q_{3b} command is

PWM_{3b}(t)=k̅₁̅(t)·s̅i̅g̅n̅(̅s̅i̅n̅(̅f̅_̅{̅g̅r̅i̅d̅}̅·̅π̅t̅)̅)̅ (7)

The analysis of T²UI is carried out for two operation modes, a continuous mode CCM and a discontinuous mode DCM.

The more efficient the switching methodology used, albeit under the same algorithm, decreases the switching frequency at Q_{1b} and Q_{2b}; so that both switches are operating at the line frequency. A more efficient control logic is as follows:

The positive half sine wave starts by charging the power inductor 12 right-handedly, as Q₂ₐ in switch 20 operates by the following command:

PWM₂ₐ(t)=k₁(t)·sign(sin(f_{grid}·πt)) (8)

and Q_{2b} in switch 20 operates by

PWM_{2b}(t)=sign (sin(f_{grid}·πt)) (9)

The Q3 switches in switch 22 operate as above and are unchanged.

In the Negative half sine wave the T²UI operates as follows. During the charge part of the cycle, the inductor is fed from the positive terminal 14 of V₁ throughout the switch Q₁ₐ by the logic

PWM₁ₐ(t)=k₁(t)·s̅i̅g̅n̅(̅s̅i̅n̅(̅f̅_̅{̅g̅r̅i̅d̅}̅·̅π̅t̅)̅)̅ (10)

and Q_{1b} operates under

PWM_{1b}(t)=s̅i̅g̅n̅(̅s̅i̅n̅(̅f̅_̅{̅g̅r̅i̅d̅}̅·̅π̅t̅)̅)̅ (11)

The Q₃ switches again operate as before.

### Simulation Results

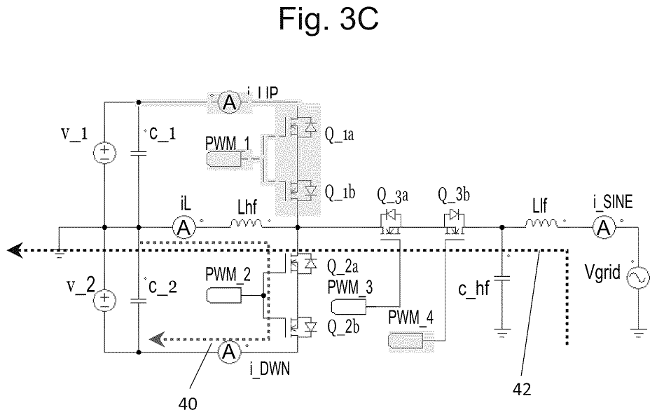

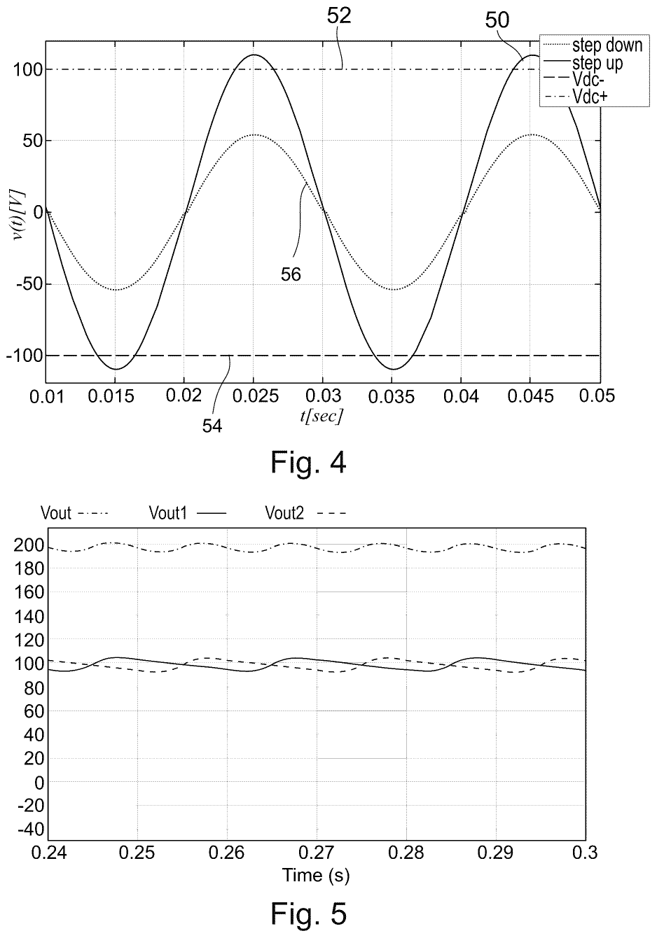

Referring now to FIG. 4, there are shown step up and step down results for step up and step down operations. Based on the above analysis, the T²UI circuit parameters for the present embodiments may be designed for open-loop conditions. Such a circuit is shown simulated using the PSIM simulation tool, and the results affirm the analytical analysis. FIG. 5 shows magnetization as a function of applied field and indicates that the T²UI is capable of delivering harmonic-less voltage and current sine waves. Referring again to FIG. 4, positive supply voltage 52 and negative supply voltage 54 are indicated. The output 50 when operated at step up is compared with the output at step down 56. The sine wave amplitude can be lower or higher than the DC supply voltage, as per the step up line 50 which exceeds the supply voltages 52 and 54. By contrast the step down line 56 lies entirely inside the supply voltages 52 and 54.

It is expected that during the life of a patent maturing from this application many relevant multi-level inverters will be developed and the scopes of this and other technical terms in the present specification are intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A multi-level t-type inverter for connecting a DC source to an AC grid, the inverter comprising:
a high frequency power inductor;
a positive terminal for connection to a positive DC voltage source;
a negative terminal for connection to a negative DC voltage source;
a grid terminal for connection to an AC grid;
a neutral terminal for connection to a neutral connection of said AC grid;
a plurality of bi-directional switches, each of said plurality of bidirectional switches defining a respectively different current path through said inverter, each path including said high frequency power inductor; and
an output LC filter.

2. The multi-level t-type inverter of claim 1, comprising a cascade loop controller, or wherein a first of said plurality of bidirectional switches is located between said power inductor and said positive AC input, a second of said plurality of bidirectional switches is located between said power inductor and said negative AC input and a third of said plurality of bidirectional switches is located between said power inductor and said output LC filter.

3. The multi-level t-type inverter of claim 2, wherein said cascade loop controller comprises an inner fast inductor current loop, a pulsed width modulator (PWM) module and a voltage control loop.

4. The multi-level t-type inverter of claim 3, wherein said cascade controller is a three loop controller, comprising a further loop, or wherein said inner fast inductor current loop is configured to initiate operation of said pulsed width modulator (PWM) module and said voltage control loop with a further loop, said further loop being one member of the group consisting of a power loop, maximum power point tracking (MPPT), a minimum fuel consumption point (MFC) and a minimization target function, or wherein said cascade loop controller is configured to charge and discharge said high frequency power inductor.

5. The multi-level t-type inverter of claim 4, wherein said further loop is one member of the group consisting of a power loop, maximum power point tracking (MPPT), a minimum fuel consumption point (MFC) and a minimization target function, or wherein said cascade loop controller is configured to charge and discharge said high frequency power inductor via a first charge path and a first discharge path for a positive half sine wave, and a second charge path and a second discharge path for a negative half sine wave, or wherein said first charge path extends from said neutral terminal to said negative AC terminal via said high frequency power inductor and a second of said bidirectional switches, or wherein said second charge path extends from said neutral AC terminal to said negative AC terminal via said high frequency power inductor and a second of said bidirectional switches, or wherein said first discharge path extends from said neutral AC terminal back to said neutral AC terminal via said high frequency power inductor, said output pair filter and a third of said bidirectional switches, wherein said second discharge path extends from said neutral AC terminal back to said neutral AC terminal via a third of said bidirectional switches and said high frequency power inductor.

6-13. (canceled)

14. The multi-level inverter of claim 1, wherein a first of said plurality of bidirectional switches is located between said power inductor and said positive AC input, a second of said plurality of bidirectional switches is located between said power inductor and said negative AC input and a third of said plurality of bidirectional switches is located between said power inductor and said output LC filter, the inverter comprising a controller for said bidirectional switches, the controller configured such that said first charge path is achieved by opening said first and third bidirectional switches and closing said second bidirectional switch, said second charge path is achieved by opening said second and third bidirectional switches and opening said first bidirectional switch, and said first and second discharge paths are achieved by opening said first and second bidirectional switches and closing said third bidirectional switch.

15. The multi-level inverter of claim 14, wherein said third bidirectional switch comprises first and second pulse width modulation (pwm) switches, and said controller is configured to initiate a positive half sine wave by charging said power inductor, by operating a first of said pwm switches using:
PWM₂ₐ(t)=k₁(t)·sign(sin(f_{grid}·πt)) (8)
and a second of said PWM switches using:
PWM_{2b}(t)=sign(sin(f_{grid}·πt)) (9)
or
wherein said controller is configured such that control logic signals for driving the switches are based on a basic modulation command
k₁(t)=α(t)·|sin(f_{grid}·πt)| (1)
where α(t) is
α(t)=V_{dc}·d(t)/((1−d(t))) (2).

16. The multi-level inverter of claim 15, wherein said first bidirectional switch comprises first and second pulse width modulation (pwm) switches and said controller is configured to initiate a negative half sine wave by feeding said power inductor by operating a first of said pwm switches of said first bidirectional switch according to
PWM₁ₐ(t)=k₁(t)·s̅i̅g̅n̅(̅s̅i̅n̅(̅f̅_̅{̅g̅r̅i̅d̅}̅·̅π̅t̅)̅)̅(10)
and operating a second of said pwm switches of said first bidirectional switch according to
PWM_{1b}(t)=s̅i̅g̅n̅(̅s̅i̅n̅(̅f̅_̅{̅g̅r̅i̅d̅}̅·̅π̅t̅)̅)̅(11).

17. (canceled)

18. The multi-level inverter of claim 14, wherein said controller is configured to charge said power inductor 12 by operating first and second pwm switches of said second bidirectional switch using:
PWM₂(t)=k₁(t)·sign(sin(f_{grid}·πt)) (3).

19. The multi-level inverter of claim 18, wherein said controller is configured to discharge said power inductor to transfer energy to the grid via said third bidirectional switch, said third bidirectional switch comprising first and second pwm switches Q₃ₐ and Q_{3b}, where Q_{3b} is idle, and Q₃ₐ is operated using
PWM₃ₐ(t)=k̅₁̅(t)·sign(sin(f_{grid}·πt)) (4)
where k̅₁̅(t)∝α̅(t) and
α̅(t)=V_{dc}·d̅(t)/((1−d̅(t))) (5).

20. The multi-level inverter of claim 19, wherein said first bidirectional switch comprises first Q₁ₐ and second Q_{1b} pwm switches, the controller being configured such that during the negative half sine wave the inductor is fed from the positive AC terminal through said first bidirectional switch, wherein said first and second pwm switches of said first bidirectional switch are operated using
PWM₁(t)=k₁(t)·s̅i̅g̅n̅(̅s̅i̅n̅(̅f̅_̅{̅g̅r̅i̅d̅}̅·̅π̅t̅)̅)̅ (6).

21. The multi-level inverter of claim 20, wherein said controller is configured to discharge said power inductor to transfer energy to the grid via said third bidirectional switch, said third bidirectional switch comprising first and second pwm switches Q₃ₐ and Q_{3b}, where Q_{3b} is idle, and Q₃ₐ is operated using
PWM_{3b}(t)=k̅₁̅(t)·s̅i̅g̅n̅(̅s̅i̅n̅(̅f̅_̅{̅g̅r̅i̅d̅}̅·̅π̅t̅)̅)̅ (7).

22. The multi-level inverter of claim 14, wherein said controller is configured to operate over a full sinusoidal cycle via a sequence comprising for each quarter of said cycle closing in order said second bidirectional switch, said third bidirectional switch, said first bidirectional switch and said third bidirectional switch.

23. (canceled)

24. A method for manufacturing a multi-level t-type inverter, for connecting a DC source to an AC grid, the method comprising:
providing a high frequency power inductor;
providing a positive terminal for connection to a positive DC voltage source;
providing a negative terminal for connection to a negative DC voltage source;
providing a grid terminal for connection to an AC grid;
providing a neutral terminal for connection to a neutral connection of said AC grid;
providing a plurality of bi-directional switches, each of said plurality of bidirectional switches defining a respectively different current path through said inverter, each path including said high frequency power inductor; and
providing an output LC filter.

25. A method for connecting a DC power source to an AC grid, comprising:
connecting a high frequency power inductor between a neutral terminal and a common terminal;
connecting a first bidirectional switch between a positive terminal of said DC power source and said common terminal;
connecting a second bidirectional switch between a negative terminal of said DC power source and said common terminal;
connecting a third bidirectional switch between said common terminal and an AC output terminal;
providing a positive half sine wave by successively closing said first and said third bidirectional switches; and
providing a negative half sine wave by successively closing said second and said third bidirectional switches.

26. The method of claim 25, comprising using an inner fast inductor current loop, a pulsed width modulator (PWM) module and a voltage control loop to control switching.

27. The method of claim 26, comprising using a further loop, said further loop being one member of the group consisting of a power loop, maximum power point tracking (MPPT), a minimum fuel consumption point (MFC) and a minimization target function.

28. The method of claim 27, wherein said inner fast inductor current loop is configured to initiate operation of said pulsed width modulator (PWM) module and said voltage control loop together with said further loop.

29. The method of claim 25, wherein said third bidirectional switch comprises first and second pulse width modulation (pwm) switches, the method comprising initiating a positive half sine wave by charging said power inductor, by operating a first of said pwm switches using:
PWM₂ₐ(t)=k₁(t)·sign(sin(f_{grid}·πt)) (8)
and a second of said PWM switches using:
PWM_{2b}(t)=sign(sin(f_{grid}·πt)) (9),
or
wherein said first bidirectional switch comprises first and second pulse width modulation (pwm) switches, the method comprising initiating a positive half sine wave by feeding said power inductor by operating a first of said pwm switches of said first bidirectional switch according to
PWM₁ₐ(t)=k₁(t)·s̅i̅g̅n̅(̅s̅i̅n̅(̅f̅_̅{̅g̅r̅i̅d̅}̅·̅π̅t̅)̅)̅ (10)
and operating a second of said pwm switches of said first bidirectional switch according to
PWM_{1b}(t)=s̅i̅g̅n̅(̅s̅i̅n̅(̅f̅_̅{̅g̅r̅i̅d̅}̅·̅π̅t̅)̅)̅ (11),
or
comprising providing control logic signals for driving the switches, which control signals are based on a basic modulation command
k₁(t)=α(t)·|sin(f_{grid}·πt)| (1)
where α(t) is
α(t)=V_{dc·}d(t)/((1−d(t))) (2).

30-31. (canceled)

32. The multi-level inverter of claim 29, the method comprising charging said power inductor 12 by operating first and second pwm switches of said second bidirectional switch using:
PWM₂(t)=k₁(t)·sign(sin(f_{grid}·πt)) (3).

33. The method of claim 32, comprising discharging said power inductor to transfer energy to the grid via said third bidirectional switch, said third bidirectional switch comprising first and second pwm switches Q₃ₐ and Q_{3b}, where Q_{3b} is idle, and Q₃ₐ is operated using
PWM₃ₐ(t)=k̅₁̅(t)·sign(sin(f_{grid}·πt)) (4)
where k̅₁̅(t)∝α̅(t) and
α̅(t)=V_{dc}·d̅(t)/(1−d̅(t))) (5).

34. The method of claim 33, wherein said first bidirectional switch comprises first Q1a and second Q1b pwm switches, the method comprising feeding the high frequency power inductor, during the negative half sine wave, from the positive AC terminal through said first bidirectional switch, wherein said first and second pwm switches of said first bidirectional switch are operated using
PWM₁(t)=k₁(t)·s̅i̅g̅n̅(̅s̅i̅n̅(̅f̅_̅{̅g̅r̅i̅d̅}̅·̅π̅t̅)̅)̅ (6).

35. The method of claim 34, comprising discharging said power inductor to transfer energy to the grid via said third bidirectional switch, said third bidirectional switch comprising first and second pwm switches Q₃ₐ and Q_{3b}, where Q_{3b} is idle, and Q₃ₐ is operated using
PWM_{3b}(t)=k̅₁̅(t)·s̅i̅g̅n̅(̅s̅i̅n̅(̅f̅_̅{̅g̅r̅i̅d̅}̅·̅π̅t̅)̅)̅ (7).
